(19) United States
(12) Patent Application Publication
(10) Pub. No.: US 2015/0149263 A1
(43) Pub. Date: May 28, 2015

(54) Automated Parking Payment

(71) Applicant: HERE Global B.V., Veldhoven (NL)

(72) Inventors: Leon Stenneth, Chicago, IL (US); Gavril Giurgiu, Chicago, IL (US)

(73) Assignee: HERE Global B.V., Veldhoven (NL)

(21) Appl. No.: 14/087,578

(22) Filed: Nov. 22, 2013

(51) Int. Cl. G06Q 20/14; G06Q 20/32; G06Q 30/02; G07F 17/24

(52) U.S. Cl. CPC G06Q 20/14; G07F 17/24; G06Q 20/3276; G06Q 30/0284
USPC 705/13

(57) ABSTRACT

A code for a parking location for a vehicle is identified. The code may be encoded in a scannable image. A processor analyzes the code for metadata for the parking location. The metadata is sent from a mobile device to a parking server along with data indicative of a beginning of a parking duration and/or data indicative of an ending of the parking duration. A parking payment may be calculated based on the parking duration by the mobile device or the parking server. An account for the vehicle may be automatically charged according to the parking payment.

### FIELD

The following disclosure relates to parking payment, or more particularly, automated wireless communication for parking payment.

### BACKGROUND

A parking meter is a device for collecting money in exchange for use of a parking spot in a particular area for a specific amount of time. Parking meters may be mechanical, electronic, or a combination. Mechanical parking meters include a coin slot to receive a coin and a dial that engages a mechanism that accepts the coin and signals that a parking fee has been paid and/or amount of time left on the parking fee. Electronic parking meters include an electronic circuit that display a readout of the remaining time based on payment received.

Each parking meter may be associated with an individual parking spot and installed near the individual parking spot. However, many cities have deployed multispace meters that control multiple spaces and are spaced several car lengths apart. Because the multispace meters are spaced several car lengths apart, the customer must walk to the multispace meter and return to the vehicle to place the parking receipt in the windshield. Also, multispace meters may be hard to identify. Thus, the driver is burdened with identifying that parking payment is required, finding the meter, providing payment, and returning to the vehicle to display the proof of payment.

### SUMMARY

In one embodiment, [will be filled in later]

### BRIEF DESCRIPTION OF THE DRAWINGS

Exemplary embodiments of the present invention are described herein with reference to the following drawings.

FIG. 1 illustrates an example system for automated parking payment detection.

FIG. 2 illustrates an example layout of parking slots and scannable codes.

FIG. 3 illustrates example scannable codes.

FIG. 4 illustrates an example wireless communication to a parking server.

FIG. 5 illustrates an example wireless communication to a parking console.

FIG. 6 illustrates example arrangements of scannable codes.

FIG. 7 illustrates an exemplary server of the system of FIG. 1.

FIG. 8 illustrates an example flowchart for automatic parking payment.

FIG. 9 illustrates an exemplary mobile device of the system of FIG. 1.

FIG. 10 illustrates another example flowchart for automatic parking payment.

### DETAILED DESCRIPTION

Automated parking payment simplifies the parking process because users do not need to locate, walk to, and provide payments to parking meters or parking consoles. The vehicle may include an automated payment system that identifies when the vehicle has entered a parking spot and when the vehicle has left the parking spot. The automated payment system may report to a parking server the amount of time that the vehicle was parked. The parking server may calculate a parking payment that is automatically debited from an account associated with the automated payment system.

The automated payment system may include a scanner, a camera, an optical reader, or another reader configured to detect a code at or near the parking spot. The code may be a quick response (QR) code, a barcode, a symbol, or an alphanumeric code. The code may painted or affixed to the street surface of the parking spot, on a curb adjacent to the parking spot, or on a structure near the parking spot. The code may be on the floor or wall of a parking garage. The code may include data indicative of the type of parking spot, the geographic location of the parking spot, and/or the rate for parking of the parking spot. The automated parking system sends the code to a centralized administrative computing device which calculates the parking payment as a function of the metadata.

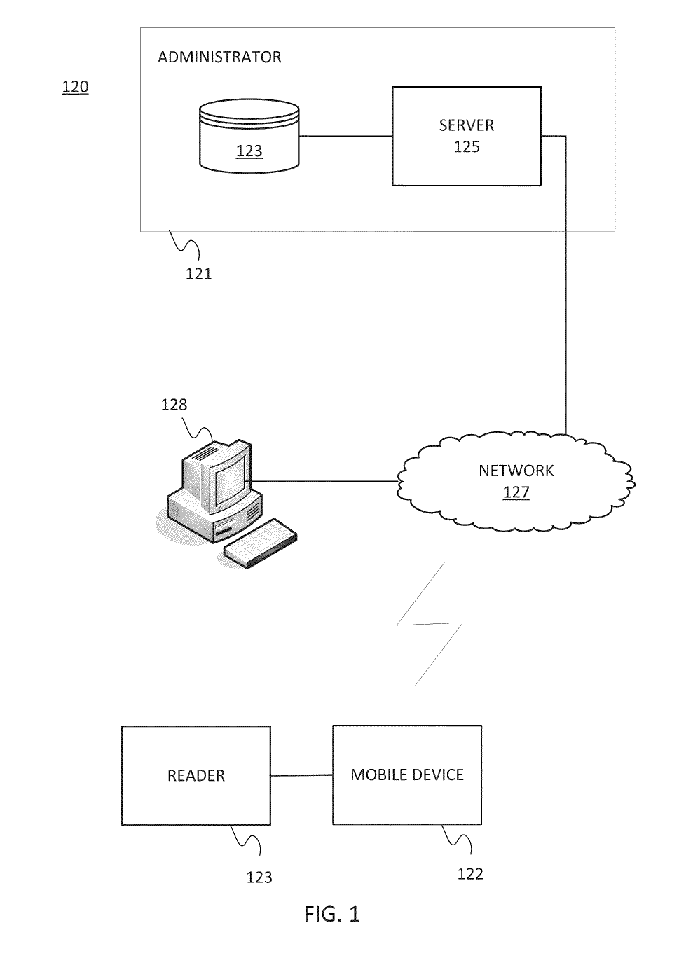

FIG. 1 illustrates an example system for automated parking payment detection. The system 120 includes an administrator system 121, a mobile device 122, a reader 123, a workstation 128, and a network 127. Additional, different, or fewer components may be provided. For example, many mobile devices 122 and/or workstations 128 connect with the network 127. The administrator system 121 includes a parking server 125 and a database 123. The administrator system 121 may include computer systems and networks of a system operator (e.g., HERE Maps, NAVTEQ or Nokia Corp.).

The mobile device 122 is a portable computer. The mobile device 122 may be a permanent component of a vehicle. The mobile device 122 may incorporated into an in-dash system of the vehicle. The mobile device 122 may be a smart phone, a mobile phone, a personal digital assistant (“PDA”), a tablet computer, a notebook computer, a personal navigation device (“PND”), a portable navigation device, and/or any other known or later developed portable or mobile computing device.

The reader 123 is in communication with the mobile device 122. The reader 123 may be an optical reader, a magnetic reader, or a radio reader. The reader 123 identifies and receives a code including metadata that describes a parking spot. The mobile device 122 may analyze the code to access the metadata for the parking location.

The optical reader may be a camera, a charge-coupled device (CCD), or another type of scanner. The camera may capture an image of the optically scannable code. The mobile device 122 interprets the optically scannable code to identify the code. Feature recognition algorithms or template matching algorithms may be applied to the image.

As a barcode scanner, the optical reader may include an illuminator, a decoder, and a sensor. The barcode scanner is configured to illuminate the barcode with a light (e.g., a red light) using the illuminator. A sensor detects the reflected light, which varies according to the dark or light portions of the barcode. The sensor generates an analog voltage signal based on the varying intensity of reflected light. The analog voltage signal may be converted by the sensor into a digital signal. The digital signal may be analyzed by the decoder. The reader 123 or the mobile device 122 may validate the barcode is decipherable, convert the barcode into characters, and formats the characters into a readable form.

The radio frequency reader may be a passive form of communication such as radio frequency identification (RFID), or an active form of communication such as Bluetooth, the IEEE 802.11 family of protocols, or another protocol. A RFID tag may transmit a radio signal or a magnetic field including the code and in response to be being energized by a signal transmitted from the reader 123. Alternatively, the RFID tag may be internally energized by a battery. The code may be transmitted by a radio frequency device in the road or curb. The radio frequency device may generate and transmit a radio frequency signal in a wireless protocol (e.g., Bluetooth, 802.11) including the code. The radio frequency signal may include data packets including the code.

The code or metadata may include a geographic data component, a parking rate data component, a parking category data component, and/or another component. The geographic data component may describe the geographic location of the parking spot. The geographic location may be a latitude value and a longitude value, a street address, or another type of location data. The geographic location may be detected by a global positioning system (GPS) or another positioning system.

The parking rate data component describes the parking rate for the parking spot. The parking rate may be a flat rate or a time based route. For example, the parking rate may be a fee per minute, per quarter hour, or per hour. The parking rate may be a function of the time of day, the day of the week, the size of the parking spot, and the category of the parking spot. The parking category data component describes the category of the parking spot. Example categories include compact car size, standard size, wide load, extended length size, or another size.

The mobile device 122 may assign a timestamp to the metadata. The timestamp may describe the time of day in hours, minutes, and seconds. The timestamp may represent the beginning of a parking duration. The mobile device 122 sends the metadata from the code and the timestamp indicative of a beginning of the parking duration to the parking server 125. The timestamp may be generated at the time of transmission of data to the parking server 125. Alternatively, the timestamp may be an ingress timestamp generated in response to the vehicle entering the parking spot.

The mobile device 122 may detect that the vehicle has entered the parking spot. The vehicle may be tracked by GPS. In addition or in the alternative, the mobile device 122 may include other positional sensors that track movement of the vehicle. The positional sensor may include one or more accelerometers, gyrometers, magnetic sensors, or other sensors.

In another example, the mobile device 122 detects that the vehicle has entered the parking spot based on receipt of the code or proximity to the code. For example, when the reader 123 comes in range to the optically scannable image or the radio signal, the mobile device 122 determines that the vehicle has parked. In another example, sensors embedded or otherwise integrated in the parking spot may detect when the vehicle has parked. A weight sensor may detect the pressure from the weight of the vehicle. An inductive sensor may detect the change in magnetic field caused by the conductive metal or electrical systems in the vehicle. In one example, a switch may be installed such that the tires of the vehicle activate the switch when the vehicle is parked. The switch may be located in one or more depressions in the road surface on which the tires of the vehicle rest when properly aligned in the parking spot.

The mobile device 122 sends another timestamp (e.g., egress timestamp) indicative of an ending of the parking duration to the parking server 125. The parking server 125 may poll or ping the mobile device 122 in predetermined intervals until the vehicle has deparked (exited the parking spot). The mobile device 122 may generate the egress timestamp in response to ignition of the vehicle, the weight of the vehicle leaving the spot, or based on the positional or the inertial sensors.

The mobile device 122 or the parking server 125 may calculate the parking duration by subtracting the ingress timestamp from the egress timestamp. The mobile device 122 may send either the parking duration or the timestamps to the parking server 125. The parking server 125 is configured to calculate a parking payment based on the parking duration and the parking rate data component from the metadata.

The parking server 125 charges the parking payment to the vehicle. A user of the vehicle may be associated with an account with the parking server 125 stored in database 123. The account may be registered with the parking server 125 with a credit card, debit card, or another form of payment. In one example, the mobile device 122 presents the user the option of registering with the parking server 125 upon entering the parking spot.

The parking server 125 is configured to analyze and verify the metadata. The parking server 125 may validate the one or more of the geographic data component, the parking rate data component, the parking category data component, and/or another component. The parking server 125 may validate the geographic component by matching the geographic location to parking spot location stored in the database 123. The database 123 may associate parking locations and/or parking rates with geographic locations of parking spots. The parking server 125 may generate a validation message that indicates whether the geographic location from the metadata corresponds to a valid parking location.

The parking server 125 may validate the parking category or the size of the parking spot. For example, the account of the vehicle may also describe the type or size of the vehicle. Example types of vehicles include motor vehicles, motorcycles and bicycles. Vehicles may be classified in size from smallest to largest in categories such as economy, compact, intermediate, standard, full size, and large size. Vehicles may be classified as car, pickup truck, minivan, sports utility, and large truck. The parking server 125 may access the size component from the metadata and compare the type or size of the vehicle to the category of the parking spot. The parking server 125 may generate a validation message that indicates whether the category or size of the parking spot is compatible with the type of vehicle.

The parking server 125 may be configured to validate that parking is permissible in the parking spot at the current time. The parking server 125 may compare the ingress timestamp to a schedule or calendar associated with the parking spot in database 123. The parking server 125 may generate a validation message that indicates whether parking at the parking spot is legal at the time listed in the timestamp. The validation message may also remind the user how much time remains for permissible parking in the parking spot.

The mobile device 122 may generate a parking availability message when the vehicle exits the parking spot. The parking availability message may be sent to the parking server 125 and distributed to mobile device 122 in other vehicles. The parking availability message may include the geographic location of the parking spot and a time that the parking spot became available. The parking available message may expire after a predetermined time period. Example predetermined time periods include 10 minutes, 1 hour, or another time value. In another example, the parking available message may remain valid until sensor data is received that another vehicle has occupied the parking spot.

The vehicle may be an autonomous vehicle. An autonomous vehicle is self-driving and may be referred to as a robot vehicle. The autonomous vehicle may include passengers but no driver is necessary. The mobile device 122 or another computer system in communication with the mobile device 122 may include instructions for operating the vehicle. For example, the computing system may generate driving commands for steering the vehicle, increasing and decreasing the throttle, and braking. The computing system may generate auxiliary commands for controlling the headlights, turn signals, windshield wipers, defrost, or other auxiliary functions not directly related to the movement of the vehicle.

The autonomous vehicle may include sensors for identifying the surrounding and location of the car. The sensors may include GPS, light detection and ranging (LIDAR), radar, and cameras for computer vision. Proximity sensors may aid in parking the vehicle. The proximity sensors may detect the curb or adjacent vehicles. The autonomous vehicle may optically track and follow lane markings or guide markings on the road.

Besides parking, the system may monitor other services available to the vehicle. For example, the mobile device 122 may record timestamps for any service provided to the automobile. In one example, the autonomous car may visit a carwash. The reader 123 may detect a code at the entrance of the carwash and another code at the exit of the carwash. The mobile device 122 or server 125 may calculate the carwash duration as the difference in timestamps associated with the entrance and exit codes. The server 125 may determine payment based on the carwash duration. Alternatively, the codes, or a single code, may include data indicative of the type of carwash, which is used for billing for the carwash. In another example, the autonomous car may visit a service station, a gas station, a ferry, or any type of service obtainable by the car.

As an example for illustration purposes, the autonomous vehicle may be summoned by the user for an airport pickup. The computing system of the autonomous vehicle checks the flights while driving to the airport and receive data that indicates the flight was delayed. The autonomous vehicle finds parking to wait for the new pickup time and pays for the parking using the automated parking payment system. In another example, the autonomous vehicle may drop the user off at home or another destination then go fight street parking without a passenger. The user may summons the vehicle using a mobile phone.

The optional workstation 128 is a general purpose computer including programming specialized for the disclosed embodiments. For example, the workstation 128 may receive user inputs for parking rates, parking schedules or calendars, vehicle sizes for types of parking spots, or other data. The workstation 128 includes at least a memory, a processor, and a communication interface.

The developer system 121, the workstation 128, and the mobile device 122 are coupled with the network 127. The phrase “coupled with” is defined to mean directly connected to or indirectly connected through one or more intermediate components. Such intermediate components may include hardware and/or software-based components.

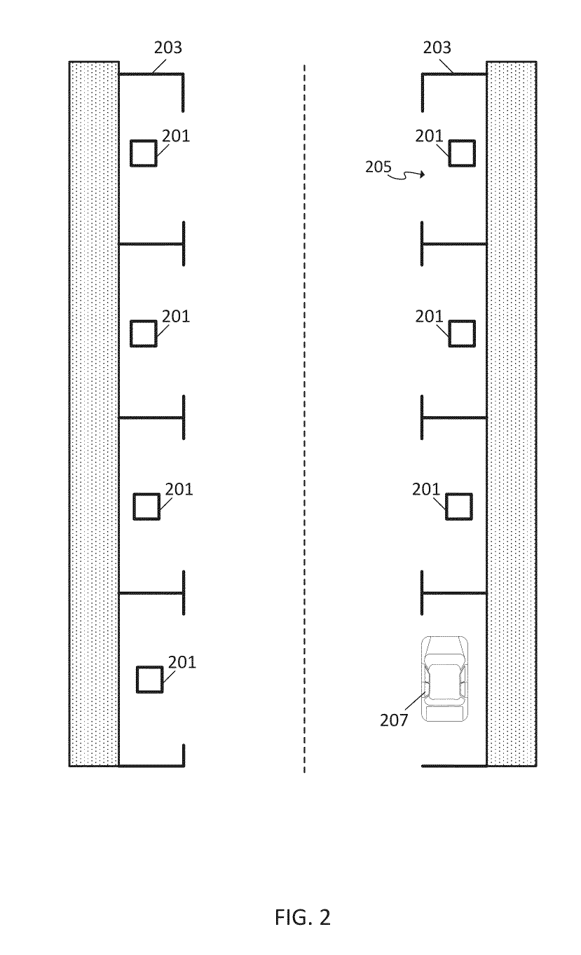

FIG. 2 illustrates an example parking layout. The parking layout includes a street and parking slots 205 on each side of the street divided by parking lines 203. Each parking slots 205 includes a scannable code 201. As vehicle 207 enters the parking slot 205, the reader 123 scans the scannable code 201.

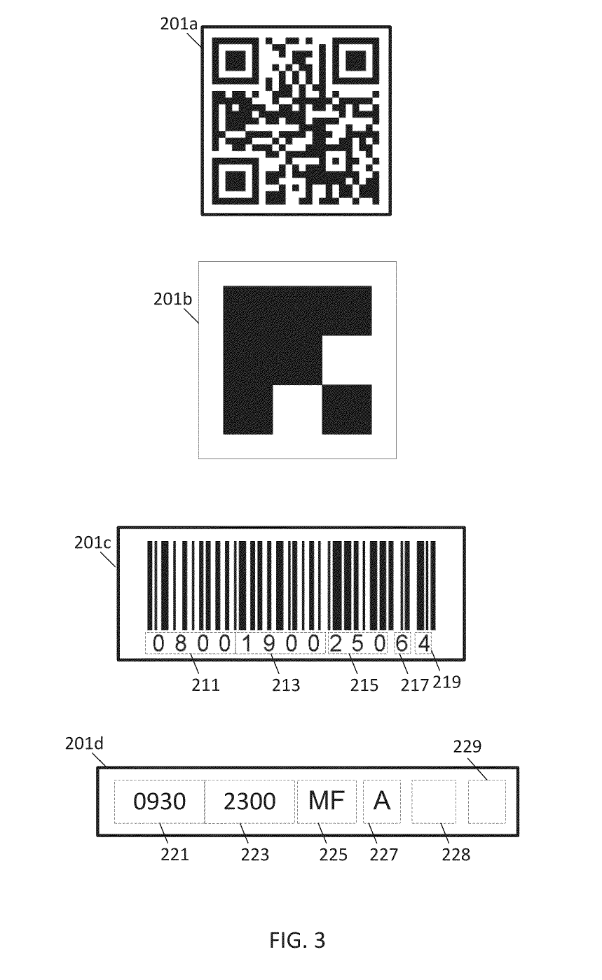

FIG. 3 illustrates example scannable codes or machine readable codes. The scannable code may be a QR code 201a, an augmented reality code 201b, a one-dimensional barcode 201c, or an alphanumeric code 201d. The QR code 201a is a matrix barcode or a barcode that extends in two-dimensions. An image of the QR code 201a is analyzed to decode the QR code 201a. The QR code 201a may be decoded by the reader 123 to reveal a text string that describes the metadata. The QR code 201a may be decoded by the reader 123 to reveal a uniform resource locator that the mobile device visits to retrieve the metadata.

The augmented reality code 201b may be a basic shape with measurable geometries (e.g., an arrangement of dark colored rectangles or a light background). The optically scannable image may include text (e.g., optically recognizable alphanumeric characters). The mobile device 122 or server 125 may analyze an image of the augmented reality code 201b and compare the augmented reality code 201b to a template. The database 123 stores templates for each type of parking spot. The mobile device 122 may recognize augmented reality code 201b as a parking spot with a rate of $1.00 per hour in which payment is required 24 hours per day.

The one-dimensional barcode 201c may include multiple parallel lines. The widths of the lines and/or the spacings between lanes may encode the data for the code. The one-dimensional barcode 201c may be a uniform product code (UPC). In one example, the data is divided into a multiple portions. A first portion 211 describes a start time of day when parking payment is required for the associated parking spot. A second portion 213 describes an end time of day, after which payment is no longer required for the parking spot. A third portion 215 may describe a parking rate per unit time for the parking spot. A fourth portion 217 may indicate a size or category of the parking spot. A fifth portion 219 may describe a maximum parking duration for the parking spot.

The alphanumeric code 201d may be letters and/or numbers that are printed on the surface of the parking spot or a sticker or sign near the parking spot. The reader 123 may capture an image of the alphanumeric code 201d. The reader 123, the mobile device 122, or the server 125 and perform optical character recognition (OCR) on the alphanumeric code 201d and identify multiple portions of the alphanumeric code 201d. The alphanumeric code 201d may include a start time 221 when payment is required and an end time 223 when payment is no longer required. In addition, a day code 225 describes the days of the week that payment is required (e.g., “MF” for Monday through Friday or “7” for seven days a week). A rate code 227 may indicate the rate for the parking spot. The rate may be constant or variable. For example, the rate may a function of the time of day, the day of the week, or the season. The rate may be increased during peak times such as business hours, near shopping season, or during times of increased tourism. The rate may also be a function of the type of vehicle. Additional fields 228 and 229 may include data indicative of the size or type of the parking spot, special access such as handicap, or a designation as been reserved by a nearby business or point of interest.

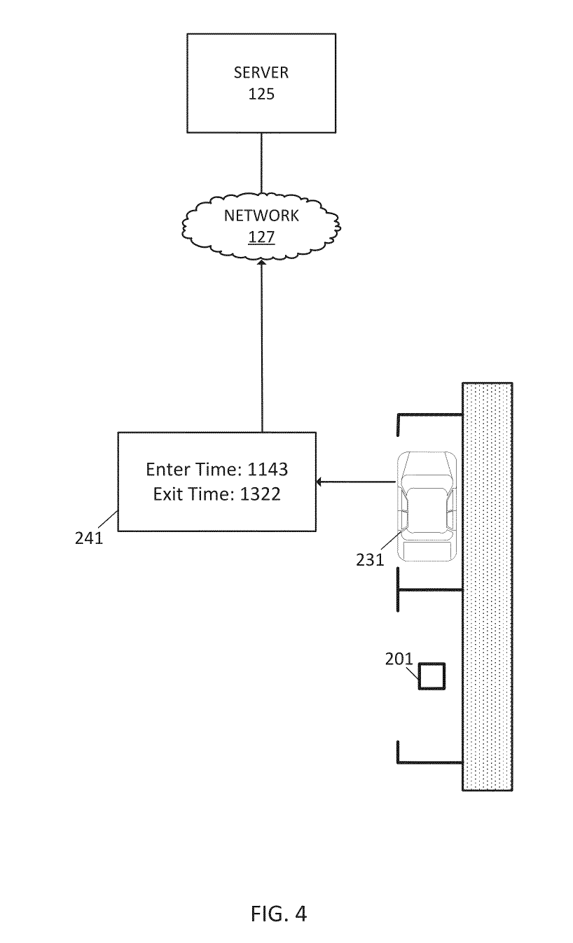

FIG. 4 illustrates an example wireless communication to the parking server 125 via network 127. The wireless communication between the vehicle 231 (mobile device 122) and the server 125 may be cellular, an Ethernet connection, any one of the family of protocols known as IEEE 802.11, any one of the family of protocols known as Bluetooth, or another type of communication. The vehicle 231 or mobile device 122 may connect with the network 127 through a communication tower or a wireless receiver near the parking spot. The vehicle 231 or mobile device 122 may generate a parking duration message 241 upon exiting the parking spot. The parking duration message 241 may include data indicative of an enter time that the vehicle 231 entered the parking spot and an exit time that the vehicle 231 exited the parking spot. Alternatively, two parking duration messages may include a enter message generated and sent to the parking server 125 when the vehicle enters the parking spot and an exit messages generated and sent to the parking server 125 when the vehicle exits the parking spot.

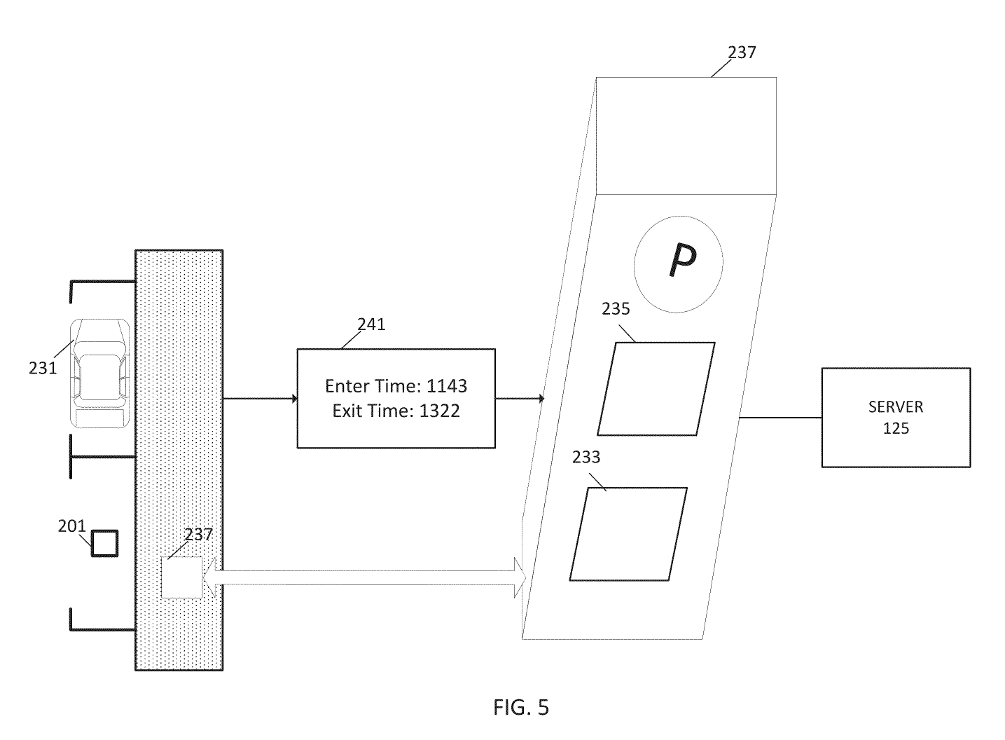

FIG. 5 illustrates an example communication to a parking console 237. The parking console 237 may be electrically coupled to sensors in the parking spot that detect when the vehicle enters or exits the parking spot. The parking console 237 may be physically coupled to the parking spot or installed within a predetermined distance (e.g., 10 meters, 100 meters, or another value) from the parking spot.

The communication between the vehicle 231 (mobile device 122) and the parking console 237 may be near-field communication, an Ethernet connection, any one of the family of protocols known as IEEE 802.11, any one of the family of protocols known as Bluetooth, or another type of communication. The parking duration message 241 including one or more of ingress times and egress times may be sent from the vehicle 231 to the parking console 237 and ultimately to the parking server 125. In one alternative, the parking console 237 may detect that the vehicle has parked (e.g., wheel sensors, weight sensors, or another sensor) and generate the ingress timestamp and egress timestamp independent of the mobile device 122. The parking console 237 may also generate the parking duration message 241 and send the parking duration message 241 to the parking server 125.

In one alternative, the parking console 237 includes manual payment for parking in addition to the automated payment. A payment portion 235 and an instruction portion 233. The parking console 237 may be installed on a ground surface (e.g., sidewalk, pavement) or mounted on a wall, utility pole, or other object. The payment portion 235 includes one or more of the following: a coin slot, a bill accepter, a credit card reader, a display, or a receipt printer. The bill accepter includes a scanner or charged coupled device (CCD) configured to read and identify various types of currency. The credit card reader may include a magnetic sensor configured to read the magnetic strip of credit cards. The receipt portion may include a printer configured to print a receipt. The receipt printer may be an ink jet printer or a thermal printer.

The instruction portion 233 may include a display screen or printed material. The instruction portion 233 may include directions for the user on how to use the parking payment console 237. In addition, the instruction portion 233 may explain that the parking spot included automated parking and describe the procedure for automated parking.

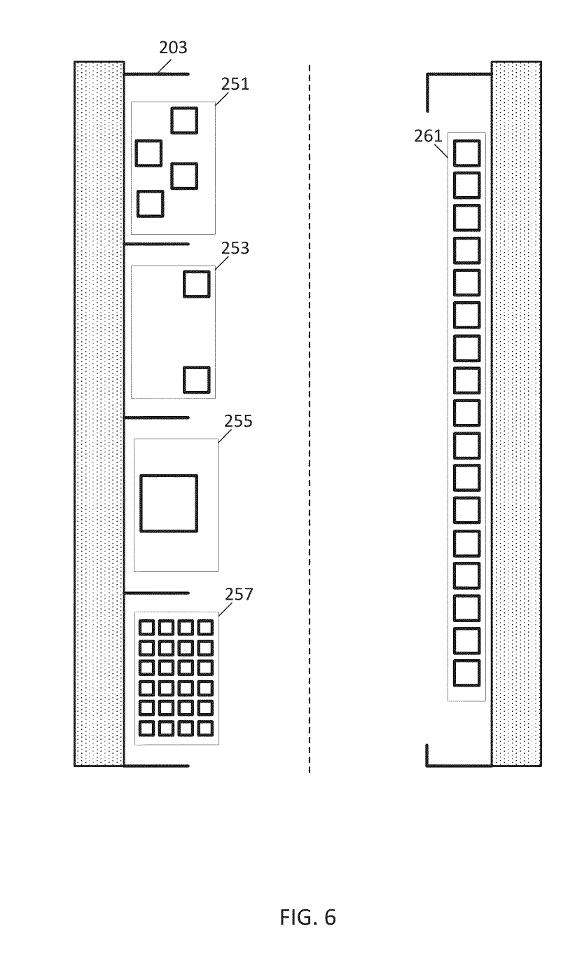

FIG. 6 illustrates example arrangements of scannable codes. To aid the reader 123 in aligning with the scannable codes 201, various patterns of codes may be used. A staggered pattern 251 includes multiple scannable codes. A corner pattern 253 includes scannable codes arranged to be captured by the reader 123 as the vehicle 231 enters and exits the parking spot. A large pattern 255 may include a large code that can be scanned from any angle as the vehicle 231 is parked. A pattern 257 may include many scannable codes so that at least one is scanned by the reader 123 no matter how the vehicle is parked. In another example, individual parking spots are not designate by lane markings. Instead, a continuous pattern 261 includes multiple scannable codes arranged so that at least one may be scanned by the reader 123 at any parking location.

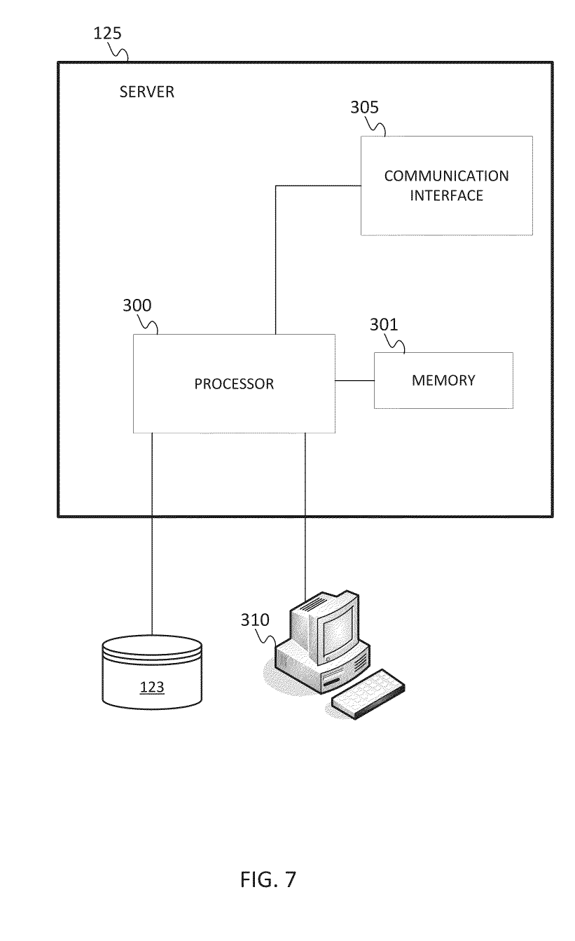

FIG. 7 illustrates an exemplary parking server 125 of the system of FIG. 1. The computing resources may be divided between the server 125 and the mobile device 122. In some embodiments, the server 125 performs a majority of the processing. In other embodiments, the mobile device 122 or the workstation 128 performs a majority of the processing. The server 125 includes a processor 300, a communication interface 305, and a memory 301. The server 125 may be coupled to a database 123 and a workstation 310. The workstation 310 may be used as an input device for the server 125. In addition, the communication interface 305 is an input device for the server 125.

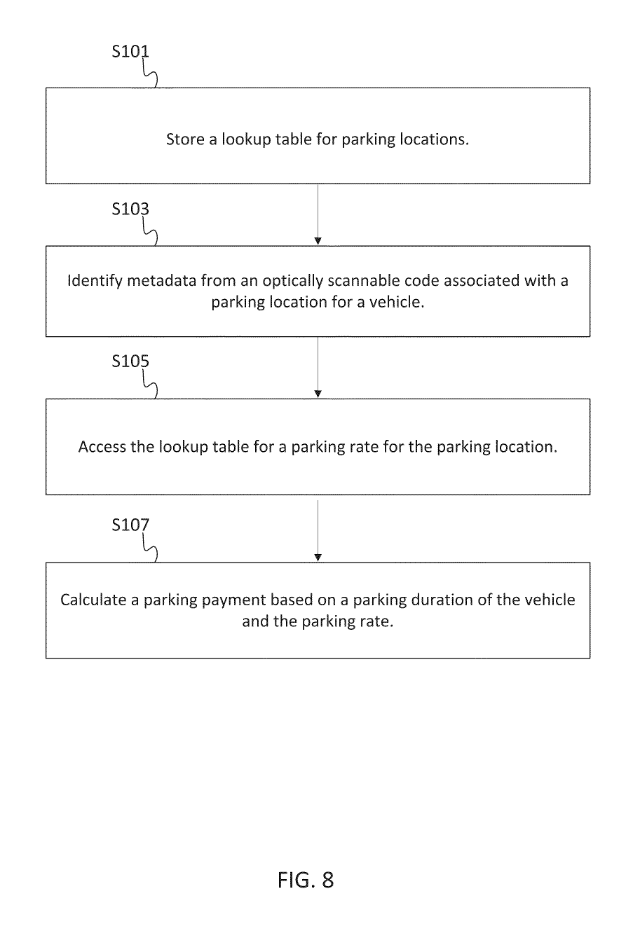

The communication interface 305 receives data indicative of use inputs made via the workstation 128 or the mobile device 122. Additional different or fewer components may be included. FIG. 8 illustrates an example flowchart for automatic parking payment, which is described in relation to the parking server 125 but may be performed by another device. Additional, different, or fewer acts may be provided.

At act S101, the memory 301 or database 123 is configured to store a lookup table for parking locations. The memory 301 or database 123 may store multiple characteristics for each parking location. The characteristics may include a parking rate, a location of the parking location, and a size for the parking location.

At act S103, the processor 300, which may be any type of controller, identifies metadata collected in proximity to the parking spot and received from a mobile device. The metadata may be included in an optically scannable code that is printed on the street surface of the parking location or on a nearby object. The metadata may include a slot identification value for the type of parking spot.

At act S105, the processor 300 accesses the lookup table using the slot identification value from the metadata. In one example, the processor 300 generates a database query including the identification value. The communication interface 305 sends the database query to the memory 301 or database 123 and receives at least the parking rate for the parking location. The communication interface 305 may also receive the category of the parking location or a schedule or calendar for the parking location.

The processor 300 may be configured to validate the parking location and the vehicle. The mobile device 122 may send a vehicle identification value with the metadata for the parking location. The vehicle identification value may describe the type of vehicle and/or an account number associated with the mobile device 122.

The processor 300 may compare the type of vehicle with the size of the parking location and generate a status message based on the comparison. When the type of vehicle is incompatible with the parking location the status message indicates that parking is not authorized. When the type of vehicle is compatible with the parking location, the status message may indicate that parking is available. The status message may also describe the parking rate for the parking location.

The processor 300 may compare the current time to the schedule or calendar for the parking location and generate a status message based on the comparison. When parking is not available at the parking location at the current time, or the time included in the timestamp, the status message indicates that parking is not authorized or that an error has occurred. When parking is available at the current time, or the time included in the timestamp, at the parking location, the status message may indicate that parking is available. The status message may also describe the parking rate for the parking location.

The status message may indicate that the mobile device 122 has been validated. When the status message indicates that parking is unauthorized, the status message may also describe a fine that may be assessed to the mobile device 122 if the vehicle remains parked. The status message may include an amount for the fine. The processor 300 may also generate a violation message to be sent to a transit authority that may assess the fine.

At act S107, the processor 300 calculates a parking payment based on a parking duration of the vehicle and the parking rate received from the memory 301 or database 123. The parking payment may be automatically debited from an account associated with the vehicle or the mobile device 122. The account data may be stored by the memory 301 or database 123.

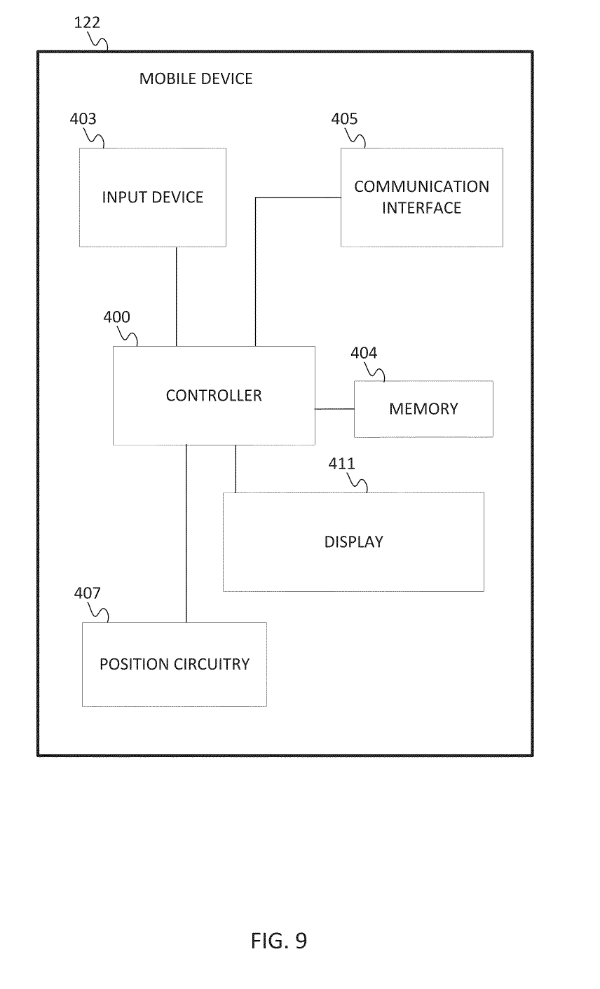

FIG. 9 illustrates an exemplary mobile device of the system of FIG. 1. The mobile device 122 may be referred to as a navigation device. The mobile device 122 includes a controller 400, a memory 404, an input device 403, a communication interface 405, a position circuitry 407, and a display 411.

The position circuitry 407 may include any combination of a position sensor, an accelerometer, and a rotation sensor. The positioning sensor may include a GPS, Global Navigation System (GLONASS), or a cellular or similar position sensor for providing location data. The position sensor may utilize GPS-type technology, a dead reckoning-type system, cellular location, or combinations of these or other systems. The position sensor may also include a receiver and correlation chip to obtain a GPS signal.

The accelerometer may be single-axis or multi-axis. The accelerometer outputs acceleration data that describes acceleration or may be manipulated to describe velocity of the mobile device 122. The accelerometer may include a damped mass coupled to a spring. In response to an acceleration force placed on the accelerometer, the mass is displaced so that the spring accelerates the mass at the same rate as the casing. The physical displacement is measured to generate the acceleration data. The accelerometer may be a piezoelectric device, a piezoresistive device, or a capacitive device to convert the mechanical motion into an electrical signal. The accelerometer may be a micro electro-mechanical system (MEMS) and may include a cantilever beam with a seismic mass in gas sealed in the device.

The rotation sensor may be a gyrometer, a compass, or a magnetic sensor. The rotation sensor is configured to generate orientation data or rotational data indicative of the relative orientation of the mobile device 122 or the vehicle. Any combination of the sensors may be included individual or integrated into an inertial measurement unit (IMU) including any combination of accelerometers, gyroscopes, and magnetometers. Other motions sensors may be used.

The controller 400 may be configured to identify a parking event that describes that a vehicle has parked. In one example, the computing system for driving an autonomous vehicle generates a parking message that is sent to the controller 400 when the vehicle has parked. In another example, the mobile device 122 transported by the vehicle identifies that the vehicle has parked. In one example, the parking of the vehicle is determined based on the location and speed of the mobile device 122. For example, when the mobile device 122 enters the known location of the parking spot, the controller 400 determines that the vehicle has parked. Alternatively, when the mobile device 122 travels at a typical driving speed (e.g., 20 mph to 80 mph) then slows to a typical speed for parking or looking for parking (e.g., 1 mph-10 mph), the controller 400 determines that the vehicle has parked. The controller 400 may also determine that the vehicle has parked when the mobile device 122 travels at the typical driving speed and stops moving for a predetermined time.

In another example, the controller 400 may identify a parking pattern of movement. For example, a parallel parking sequence may include several steps. First, the automobile stops ahead of the parking spot in the direction of travel. Second, the automobile moves at an angle into the parking spot. The angle may be 20 to 45 degrees. The automobile turns in the opposite position to straighten in the parking spot. Alternatively, the analysis to determine parking event may be performed by the server 125.

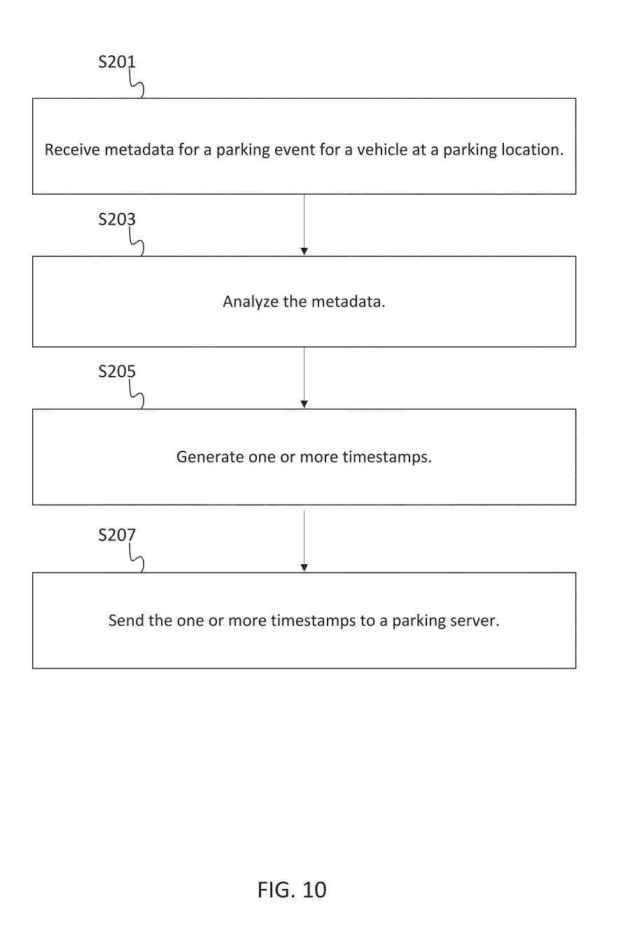

FIG. 10 illustrates an example flowchart for automatic parking payment, which is described in relation to the mobile device 122 but may be performed by another device. The mobile device 122 may include a mobile application for performing the detection of the parking event and/or automatic parking payment. Additional, different, or fewer acts may be provided.

At act S201, the controller 400 receives metadata for a parking event for a vehicle at a parking location. The metadata may be collected by an optical scanner. The controller 400 may instruct the optical scanner to collect the metadata in response to the detection of the parking event.

At act S203, the controller 400 either forwards the metadata to the parking server 125 or analyzes the metadata locally. The metadata may be analyzed to identify whether parking is available at the parking spot, whether a vehicle classification is compatible with the spot, and/or a parking rate for the parking spot.

At act S205, the controller 400 generates one or more timestamps associated with the parking event. A first timestamp may be generated at the beginning of the parking event when the vehicle enters the parking spot. A second timestamp may be generated at the end of the parking event when the vehicle leaves the parking spot.

At act S207, the communication interface 405 sends the one or more timestamps to the parking server 125, and the parking server 125 calculates the parking payment based on the timestamps. Alternatively, the controller 400 calculates the parking payment based on the timestamps.

The input device 403 may be one or more buttons, keypad, keyboard, mouse, stylist pen, trackball, rocker switch, touch pad, voice recognition circuit, or other device or component for inputting data to the mobile device 122. The input device 403 and the display 411 may be combined as a touch screen, which may be capacitive or resistive. The display 411 may be a liquid crystal display (LCD) panel, light emitting diode (LED) screen, thin film transistor screen, or another type of display.

The controller 400 and/or processor 300 may include a general processor, digital signal processor, an application specific integrated circuit (ASIC), field programmable gate array (FPGA), analog circuit, digital circuit, combinations thereof, or other now known or later developed processor. The controller 400 and/or processor 300 may be a single device or combinations of devices, such as associated with a network, distributed processing, or cloud computing.

The memory 404 and/or memory 301 may be a volatile memory or a non-volatile memory. The memory 404 and/or memory 301 may include one or more of a read only memory (ROM), random access memory (RAM), a flash memory, an electronic erasable program read only memory (EEPROM), or other type of memory. The memory 404 and/or memory 301 may be removable from the mobile device 100, such as a secure digital (SD) memory card.

The communication interface 405 and/or communication interface 305 may include any operable connection. An operable connection may be one in which signals, physical communications, and/or logical communications may be sent and/or received. An operable connection may include a physical interface, an electrical interface, and/or a data interface. The communication interface 405 and/or communication interface 305 provides for wireless and/or wired communications in any now known or later developed format.

The network 127 may include wired networks, wireless networks, or combinations thereof. The wireless network may be a cellular telephone network, an 802.11, 802.16, 802.20, or WiMax network. Further, the network 127 may be a public network, such as the Internet, a private network, such as an intranet, or combinations thereof, and may utilize a variety of networking protocols now available or later developed including, but not limited to TCP/IP based networking protocols.

In addition to the parking spot locations, categories, schedules, rates, and related information, the database 123 may store or maintain geographic data such as, for example, road segment or link data records and node data records. The link data records are links or segments representing the roads, streets, or paths. The node data records are end points (e.g., intersections) corresponding to the respective links or segments of the road segment data records. The road link data records and the node data records may represent, for example, road networks used by vehicles, cars, and/or other entities. The road link data records may be associated with attributes of or about the roads such as, for example, geographic coordinates, street names, address ranges, speed limits, turn restrictions at intersections, and/or other navigation related attributes (e.g., one or more of the road segments is part of a highway or tollway, the location of stop signs and/or stoplights along the road segments), as well as points of interest (POIs), such as gasoline stations, hotels, restaurants, museums, stadiums, offices, automobile dealerships, auto repair shops, buildings, stores, parks, etc. The node data records may be associated with attributes (e.g., about the intersections) such as, for example, geographic coordinates, street names, address ranges, speed limits, turn restrictions at intersections, and other navigation related attributes, as well as POIs such as, for example, gasoline stations, hotels, restaurants, museums, stadiums, offices, automobile dealerships, auto repair shops, buildings, stores, parks, etc. The geographic data may additionally or alternatively include other data records such as, for example, POI data records, topographical data records, cartographic data records, routing data, and maneuver data.

The databases 123 may be maintained by one or more map developers (e.g., the first company and/or the second company). A map developer collects geographic data to generate and enhance the database. There are different ways used by the map developer to collect data. These ways include obtaining data from other sources such as municipalities or respective geographic authorities. In addition, the map developer may employ field personnel (e.g., the employees at the first company and/or the second company) to travel by vehicle along roads throughout the geographic region to observe features and/or record information about the features. Also, remote sensing such as, for example, aerial or satellite photography may be used.

The database 123 may be master geographic databases stored in a format that facilitates updating, maintenance, and development. For example, a master geographic database or data in the master geographic database is in an Oracle spatial format or other spatial format, such as for development or production purposes. The Oracle spatial format or development/production database may be compiled into a delivery format such as a geographic data file (GDF) format. The data in the production and/or delivery formats may be compiled or further compiled to form geographic database products or databases that may be used in end user navigation devices or systems.

For example, geographic data is compiled (such as into a physical storage format (PSF) format) to organize and/or configure the data for performing navigation-related functions and/or services, such as route calculation, route guidance, map display, speed calculation, distance and travel time functions, and other functions, by a navigation device. The navigation-related functions may correspond to vehicle navigation, pedestrian navigation, or other types of navigation. The compilation to produce the end user databases may be performed by a party or entity separate from the map developer. For example, a customer of the map developer, such as a navigation device developer or other end user device developer, may perform compilation on a received geographic database in a delivery format to produce one or more compiled navigation databases.

The memory 404 and/or memory 301 may be a non-transitory computer-readable medium. While the non-transitory computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network device.

Processors suitable for the execution of a computer program include, by way of example, both general and special purpose microprocessors, and anyone or more processors of any kind of digital computer. Generally, a processor receives instructions and data from a read only memory or a random access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A method comprising:
identifying an optically scannable code associated with a parking location for a vehicle;
analyzing, using a processor, the optically scannable code for metadata for the parking location;
sending, to a parking server, the metadata from the optically scannable code in response to a beginning of a parking duration; and
sending, to the parking server, a final timestamp indicative of an ending of the parking duration.

2. The method of claim 1, further comprising:
sending vehicle identification data with an initial timestamp, wherein the vehicle identification data verifies the vehicle for the parking location.

3. The method of claim 1, wherein the code is a quick response (QR) code, a bar code, or an alphanumeric code.

4. The method of claim 1, wherein identifying the scannable code comprises:
capturing an image including the scannable code.

5. The method of claim 1, wherein the metadata includes data indicative of a size of the parking location or data indicative of a category of the parking location.

6. The method of claim 1, further comprising:
receiving positional data for the vehicle, wherein the positional data indicates that the vehicle is entering the parking location; and
initiating a scan for the optically scannable code in response to the positional data that indicates that the vehicle is entering the parking location.

7. The method of claim 1, further comprising:
receiving positional data for the vehicle, wherein the positional data indicates that the vehicle is exiting the parking location; and
generating the final timestamp in response to the positional data that indicates that the vehicle is exiting the parking location.

8. The method of claim 1, further comprising:
establishing wireless data communication with the parking server.

9. A method comprising:
receiving metadata derived from an optically scannable code of a parking location;
receiving a first timestamp indicative of a start of a parking duration;
verifying the metadata;
receiving a second timestamp indicative of an end of the parking duration;
calculating a parking payment based on the parking duration; and
charging the parking payment according to the metadata.

10. The method of claim 9, wherein the metadata includes data indicative of a size of the parking location or data indicative of a category of the parking location.

11. The method of claim 9, further comprising:
decoding the optically scannable code, wherein the code is a quick response (QR) code, a bar code, or an alphanumeric code.

12. An apparatus comprising:
at least one processor; and
at least one memory including computer program code for one or more programs,
the at least one memory and the computer program code configured to, with the at least one processor, cause the apparatus to perform at least the following,
receive metadata for a parking event for a vehicle at a parking location;
analyze the metadata;
generate one or more timestamps; and
send the one or more timestamps to a parking server, wherein a parking payment is calculated based on the one or more timestamps.

13. The apparatus of claim 12, wherein the metadata is collected by an optical scanner, a magnetic sensor, or a radio frequency antenna.

14. The apparatus of claim 12, wherein the metadata is encoded in a quick response code.

15. The apparatus of claim 12, wherein the metadata includes data indicative of a size of the parking location or data indicative of a category of the parking location, and the at least one processor is configured to validate the parking location based on the metadata.

16. The apparatus of claim 12, further comprising:
position circuitry configured to detect that the vehicle is entering the parking location, wherein the at least one processor initiates a scan for optically scannable code including the metadata in response to the vehicle entering the parking location.

17. The apparatus of claim 12, wherein the one or more timestamps include an ingress timestamp triggered by the vehicle entering the parking location and an egress timestamp triggered by the vehicle exiting the parking location.

18. An apparatus comprising:
at least one processor; and
at least one memory including computer program code for one or more programs and a lookup table for parking locations,
the at least one memory and the computer program code configured to, with the at least one processor, cause the apparatus to perform at least the following,
identify metadata from an optically scannable code associated with a parking location for a vehicle;
access the lookup table for a parking rate for the parking location; and
calculate a parking payment based on a parking duration of the vehicle and the parking rate.

19. The apparatus of claim 18, wherein the at least one processor is configured to calculate the parking duration as a difference between an egress time and an ingress time for the vehicle.

20. The apparatus of claim 18, wherein the at least one processor is configured to access an account associated with the vehicle and charge the account according to the parking payment.
